(19) United States
(12) Patent Application Publication
(10) Pub. No.: US 2020/0401582 A1
(43) Pub. Date: Dec. 24, 2020

(54) LOW-LATENCY TYPEAHEAD WITH IMPROVED RECALL

(71) Applicant: Microsoft Technology Licensing, LLC, Redmond, WA (US)

(72) Inventors: Hitesh Kumar, San Francisco, CA (US); Michael Mario Jennings, San Francisco, CA (US)

(21) Appl. No.: 16/450,851

(22) Filed: Jun. 24, 2019

(51) Int. Cl. G06F 16/242; G06F 16/23; G06F 16/2457; G06F 16/28; G06F 16/2458

(52) U.S. Cl. CPC G06F 16/2425; G06F 16/2379; G06F 16/2458; G06F 16/288; G06F 16/24578

(57) ABSTRACT

In an embodiment, the disclosed technologies include a method for generating a typeahead suggestion list for an input field of a search interface, including receiving, as digital input, a query string that has been extracted from the input field and context data that comprises one or more of: a search term that has been extracted from another input field of the search interface or a search criterion that has been extracted from a member profile that is associated with the query string via an online connection network; executing, on digital data extracted from the online connection network, one or more machine-readable queries that comprise one or more of the query string and the context data, to produce a set of candidate entities; outputting at least part of the set of candidate entities as a suggestion list that the search interface may display in association with the input field to facilitate query formulation via the input field.

### TECHNICAL FIELD

A technology related to this disclosure is query formulation. Another technology related to this disclosure is online information search and retrieval using standardized terms.

### BACKGROUND

Query formulation refers to an automated process by which a human readable search query is converted into a structured query representation that can be executed by a computer-implemented search engine. Typeahead technologies have been used to help speed up interactive query formulation processes.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

In the drawings:

FIG. 1 is a flow diagram, in an embodiment;

FIG. 2 is a block diagram that depicts an example software-based system, in an embodiment;

FIG. 3 is a block diagram of a networked computing system, in an embodiment;

FIG. 4A and FIG. 4B are screen captures of examples of typeahead suggestion lists, in an embodiment;

FIG. 5 is a block diagram that illustrates a computer system upon which an embodiment of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

General Overview

In information retrieval technologies, recall may refer to a measure of a system's ability to retrieve relevant search results—for example, out of all of the relevant documents that possibly could have been retrieved in response to a query, how many of those relevant documents did this particular query actually retrieve?

A technical limitation of existing typeahead technologies is that they require prefix matching. Prefix matching typeahead technologies suffer from poor recall particularly when, for example, the user entering the query is in a hurry or is uncertain as to how to formulate the query to get the desired result set. For instance, the user may just start typing, or speaking, if a speech to text interface is provided, the first word that comes to mind, which may not produce the most relevant typeahead suggestion list. Consequently, the user will need to spend more time thinking about which entry to select from the suggestion list to complete the search query, and the user may be overwhelmed or confused by the choices presented in the suggestion list.

Additionally, prefix matching will not include in the suggestion list potentially highly relevant suggestions if they do not have a prefix that matches the query input. When relevant suggestions are omitted from the suggestion list, the user does not have a chance to select them for inclusion in the search query being formulated. As a result, when executed by a search engine, the search query formulated using an entry selected from the suggestion list is likely to return a sub-optimal result set.

Another technical limitation of existing typeahead technologies is that suggestion lists, which are automatically generated by the typeahead technologies, tend to contain a lot of synonyms and duplicate entries, which do not help the user focus the search. Consequently, the resulting query formulated with an entry from the suggestion list is likely to be overbroad, returning too many hits when executed by a search engine.

Still another technical limitation of existing typeahead technologies is that candidate entries for the suggestion list are often ranked based on popularity or frequency of use. This ranking approach is not suitable for all applications in which typeahead suggestion lists are useful. For example, some applications require the search engine to return targeted results that are not necessarily the most common or most popular items.

Yet another technical limitation of existing typeahead technologies is that the suggestion list is generated only based on the actual text stream being input as the search query, without any consideration of other information that could improve the quality of the entries in the suggestion list.

Embodiments of the disclosed approaches address these and other technical limitations of the existing approaches. In an embodiment, context data representative of user context and/or query context is used to influence the selection of candidates and/or the ranking of candidates for the suggestion list. User context may include, for example, member profile data extracted from an online connection network. Query context may include, for example, a search criterion indicated in another part of the search interface, for example text or selections made via interactive graphical elements that may be displayed adjacent to the query input box on the search interface.

In an embodiment, an indexed, searchable digital taxonomy identifies relationships between canonical entities, for example standardized terms, and non-canonical entities, for example aliases and other non-standardized terms. The taxonomy can be used to determine one or more canonical entities to include in or exclude from a suggestion list and/or to determine one or more non-canonical entities to include in or exclude from a suggestion list.

Portions of the taxonomy can be selectively indexed. For example, only canonical entities are indexed in one embodiment, while in another embodiment, canonical entities and certain selected non-canonical entities are indexed. In an embodiment, at least part of the taxonomy is created using data that has been extracted from an online connection network. In an embodiment, the taxonomy is used to determine whether candidate entities are complete or incomplete. In an embodiment, ranking logic prioritizes complete entities over incomplete entities for inclusion in the suggestion list. In an embodiment, the taxonomy is stored and indexed in volatile memory, using in-memory indexing, to improve latency.

Benefits that may be realized by at least some embodiments described herein include improved recall and reduced latency of typeahead suggestion lists. Improved recall means that the typeahead suggestion list created as disclosed herein contains candidate entities that are likely to be more relevant to the intended search and thus more likely to retrieve highly relevant search results when the ultimately formulated query is executed by a search engine. Reduced latency means that the typehead suggestion list created as disclosed herein is generated and displayed to the user quickly, for example in response to the user typing or speaking a query input. This in turn improves the likelihood that a highly relevant candidate entity will be selected from the suggestion list and incorporated into the ultimately formulated search query.

Some of these aspects may be particularly beneficial in applications that require structured keyword searching. For example, in online job searching applications and online talent searching applications, searches for people and/or jobs having particular skills and job titles are common. However, the way that skills and job titles are described by different people and companies can vary widely, particularly across a large population of users. Thus, using too specific of a search term may not yield any results, while using too general of a search term may yield a large number of irrelevant results. The disclosed typeahead technologies can accommodate the need for particularized suggestion lists while also improving recall.

The disclosed technologies are not limited to the above-described embodiments, features, and advantages. For example, while some embodiments are disclosed in the context of standardized text searching, aspects of the disclosed technologies also are applicable to free text searching. Additionally, while embodiments may be disclosed in the context of job search applications and/or talent search applications, aspects of the disclosed technologies are equally applicable to other domains as well as to generalized, domain-independent search engines. Other embodiments, features and aspects will become apparent from the disclosure as a whole.

Suggestion List Generation

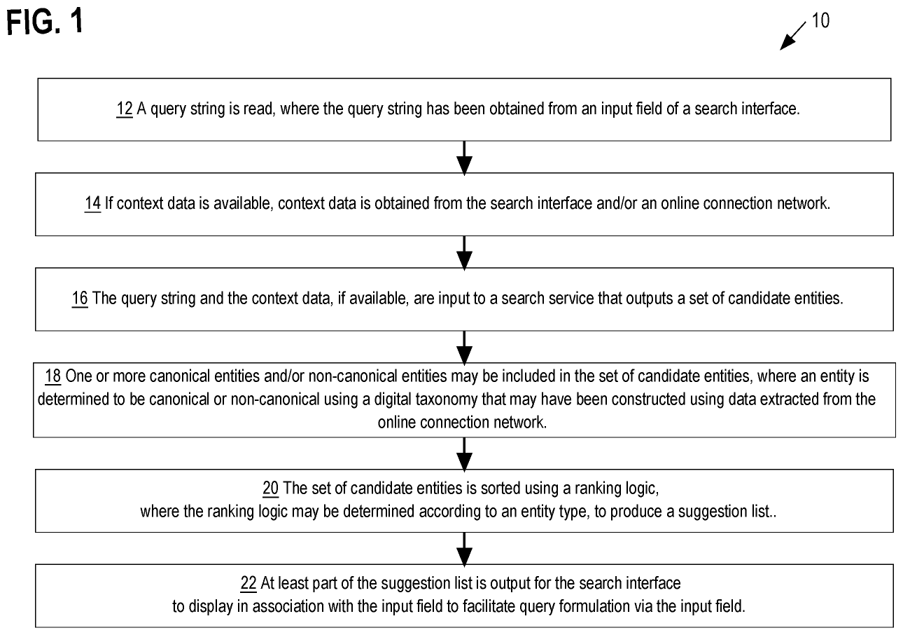

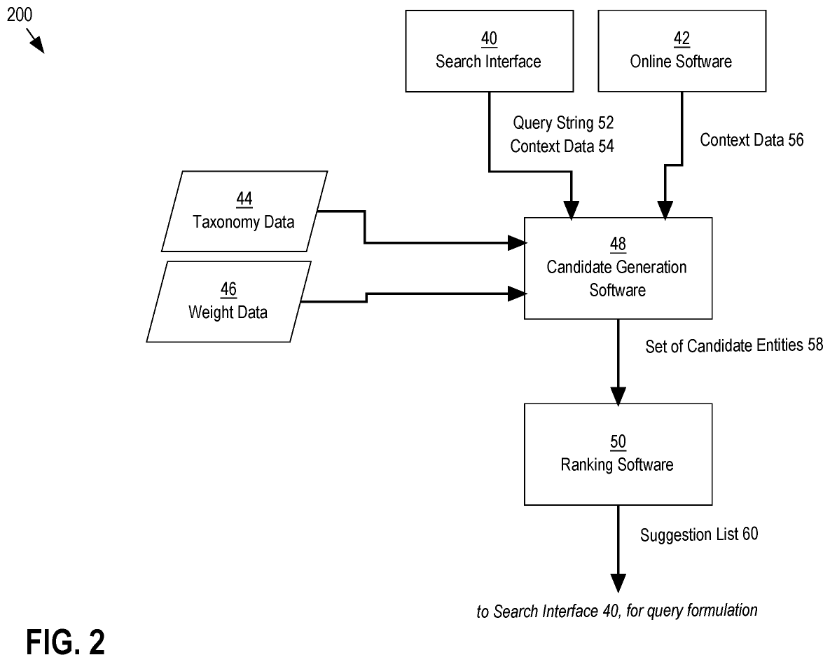

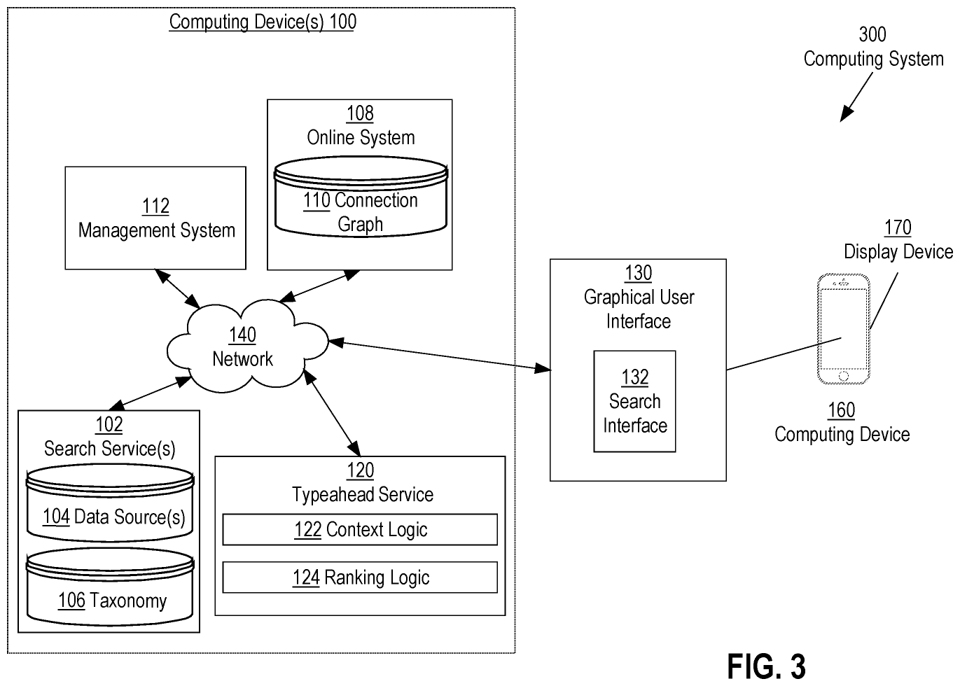

FIG. 1 is a flow diagram that depicts a process 10 that is performed by one or more components of a computing system, examples shown in FIGS. 2 and 3 described below, in an embodiment. In some embodiments, portions of process 10 are performed by candidate generation software 48 and ranking software 50, shown in FIG. 2, described below. In some embodiments, candidate generation software 48 and ranking software 50 are components of typeahead service 120, shown in FIG. 3. For example, context logic 122 may be implemented as part of candidate generation software 48 and ranking logic 124 may be implemented as part of ranking software 50. Portions of process 10 may be performed by a single entity or program or by multiple entities or programs, including for example a browser plug-in and a remote server.

The operations of the process as shown in FIG. 1 are implemented using processor-executable instructions that are stored in computer memory. For purposes of providing a clear example, the operations of FIG. 1 are described as performed by computing device(s) 100, 160, which may be individually or collectively referred to simply as a ‘computing system.’

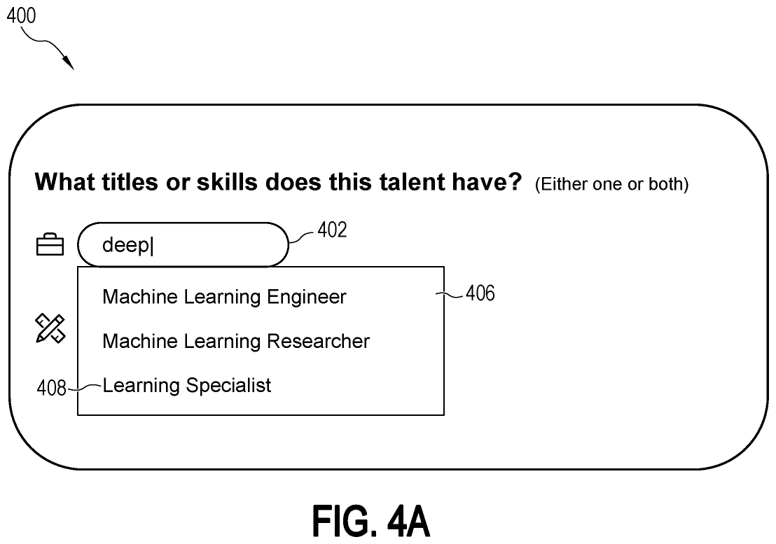

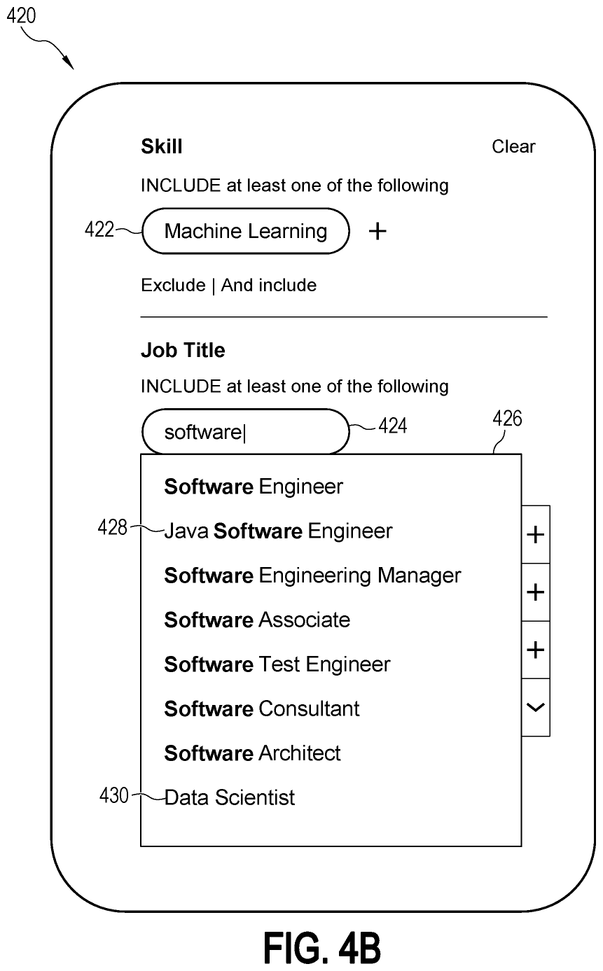

In operation 12, process 10 reads a query string, where the query string has been extracted from an input field of a search interface via a web browser front end. In an embodiment, reading the query string involves the web browser passing the query string to the typeahead service via an API layer. The query string contains text that has been received via an input device, such as text that has been typed by a user via a keypad or keyboard, or text that has been automatically converted from speech spoken by the user into a microphone, via an automated speech to text service such as an automated speech recognition (ASR) engine. Examples of query strings entered into input fields are shown in FIG. 4A and FIG. 4B, which are described below.

In operation 14, process 10 determines whether context data is available. Context data may be available, for example, if the user has input data or selected items in other parts of the search interface, or if the user has previously conducted a search using the search interface, or if the user has an account on an online connection network with which the search interface is communicatively coupled. For instance, context data may include additional search terms or search parameters that have been input or selected via other interactive elements of the search interface, and/or context data may include the user's company name as retrieved from the user's member profile on the online connection network.

If context data is available, then context data is extracted from the search interface and/or the online connection network, as the case may be. Any available context data may be extracted via, for example, an API layer such as a REST API.

In operation 16, process 10 calls a search service using the query string and context data extracted in operation 14 as arguments. In an embodiment, a federation service performs a federated search process to coordinate searching of digital data extracted from portions of the online connection network by multiple different distributed search services and combines the results retrieved by the distributed search services to generate the set of candidate entities. In an embodiment, the federation service performs query understanding, query rewriting and scatter-gather to a plurality of search verticals, such as LINKEDIN GALENE or APACHE LUCENE search instances, which execute searches on various different data sources that contain digital data extracted from the online connection network. Query rewriting involves converting a raw query to a form that can be executed by the receiving search engine.

The search verticals retrieve and return their respective search results to the calling process, which combines and annotates the collective results and returns the combined results to the front-end search interface via the typeahead resource, as a set of candidate entities. In an embodiment, retrieval includes fetching results from search indexes such as LINKEDIN GALENE indexes. In an embodiment, results are ranked after retrieval and prior to return to the front end. For example, results may be ranked in decreasing order according to a frequency of occurrence score, where the frequency of occurrence score equates to a count of members of the online connection network that have data, in their member profile or in a particular field of their member profile, that matches the query string and/or context data.

In an embodiment, the search verticals engaged by operation 16 vary in terms of their ability to accept input and/or their retrieve results with low latency. For example, some of the search services may only accept the query string as input while others of the search services may only accept context data as input, while still others may accept either or both of query string and context data. To accommodate these variations among search services, the number and types of search services used is configurable according to the requirements of a particular application. For example, each search service is assigned a preference weight that is used when results from all of the search services are combined. In an embodiment, the results returned by the search services are combined using a LIX index to produce the set of candidate entities.

The search results retrieved and included in the set of candidate entities by operation 16 can include only canonical entities or a combination of canonical entities and non-canonical entities. Examples of canonical and non-canonical entities that may be included in the set of candidate entities are shown in FIG. 4A and FIG. 4B, described below.

In some embodiments, operation 18 of process 10 uses a digital taxonomy to determine the set of candidate entities based on whether particular entities are canonical or non-canonical. In an embodiment, the digital taxonomy has been constructed using data extracted from the online connection network. For example, the digital taxonomy may define “Software Engineer” as a canonical entity for job title.

The search services used in operation 16 may return results that indicate that members of the online connection network also use other titles to refer to similar job opportunities, occupations or skill sets. For example, a search service searching member profile data may return a result set that includes “Software Developer,” “Software Associate” and other similar names. The taxonomy defines logical links between these alternative titles and the canonical title, in a hierarchical fashion, in an embodiment. Thus, traversing the taxonomy allows process 10 to identify one or more non-canonical entities that are associated with a particular canonical entity. In this way, a query string that maps to a non-canonical entity in the taxonomy can be mapped to the related canonical entity via the non-canonical entity, and the canonical entity rather than the non-canonical entity may be included in the suggestion list. In other embodiments, certain selected non-canonical entities may be indexed and included in a suggestion list. For example, if the system determines that a frequency of occurrence of a non-canonical entity in member profiles of the online connection network exceeds a threshold, the non-canonical entity may be indexed and thus, the non-canonical entity may be added to a suggestion list. In an embodiment, operation 18 traverses the digital taxonomy in volatile memory of the one or more computing devices using in-memory indexing.

In operation 20 the set of candidate entities is sorted using, for example, ranking logic or a machine learning technique such as Learning to Rank. The ranking logic may be determined according to an entity type, to produce a suggestion list. For example, title and skills are entity types, in an embodiment, and the ranking logic is different for each of these entity types. In an embodiment, for the title entity type, the ranking logic only ranks canonical entities and does not include any non-canonical entities, such as aliases or related titles, in the set of candidate entities that is ranked. In an embodiment, a multiple step ranking logic is used, as follows: canonical entities that exactly match the query string are ranked highest, followed by entities of a certain entity type (for example, occupation) that are complete, followed by entities that are not of that certain entity type but are complete, followed by entities that are not complete but do contain a value for a certain entity (for example a title that has a role but not a specialty).

Whether an entity is complete or incomplete is determined using the taxonomy, in an embodiment. For example, for the entity type occupation, the taxonomy may indicate that the entity has two attributes, role and specialty. Examples of titles that are complete and also occupations are Software Engineer and Product Manager. These titles are complete because they contain a role (Engineer, Manager) and a specialty (Software, Product). An example of a title that is complete but is not an occupation is Senior Software Engineer. Thus, in an embodiment, a title is a particular variation of an occupation, for example Senior, Junior, etc. Examples of titles that have a role but not a specialty are Manager, Engineer. The above-described examples are used only for illustration purposes. The particular entity types that are used to determine ranking logic, and the particular attributes that are used to determine completeness, are configurable according to the requirements of a particular application or system.

Alternatively or in addition, operation 20 ranks entities retrieved by search services of the plurality of distributed search services according to a latency bias. The latency bias causes entities retrieved by a search service that has a lower latency to be ranked higher than entities retrieved by a search service that has a higher latency when low latency is preferred and the latency bias causes entities retrieved by a search service that has a higher latency to be ranked higher than entities retrieved by a search service that has a lower latency when search quality is preferred.

In operation 22, at least part of the set of candidate entities that has been ranked in operation 20 is output as a suggestion list that the search interface may display in association with the input field to facilitate query formulation via the input field in which the query string was input. For example, the suggestion list may be displayed in a list box that is adjacent to the input field on the search interface. A user may interact with the list box in order to select a candidate entity from the suggestion list. In response to a selection identifying a selected entity in the suggestion list, the search interface replaces the query string in the input field with the entity selected from the list box. Replacing the query string with the selected entity contributes to query formulation. The user may then add or remove search terms and/or search parameters before executing the query. Once the user is satisfied with the content of the query, the user initiates an action via the search interface to execute the query. Results of the executed query, which has been formulated using the disclosed typeahead suggestion technologies, may be displayed via the search interface.

Typehead Service

FIG. 2 is a block diagram that depicts an example system for automatically providing a typeahead suggestion list, in an embodiment. The software-based components of the system of FIG. 2 include search interface 40, online software 42, candidate generation software 48, ranking software 50, taxonomy data 44, and weight data 46.

Search interface 40 is software that presents a graphical user interface through which query strings are received. Search interface 40 may be part of a front end through which a user searches online job postings for jobs that match a particular skill or title, or a user searches online member profiles for talent that matches the title or skill set of a particular job opening. Examples of search interface 40 include but are not limited to the “Search” input box of the LINKEDIN online connection network or the “Jobs” component of the LINKEDIN mobile device software application, or the search interface of the LINKEDIN TALENT SOLUTIONS product, each provided by LinkedIn Corporation of Sunnyvale, Calif. Other examples of search interface 40 include other online job listing services, recruiter-oriented online services, and online search engines.

Users of search interface 40 may or may not be registered in online software 42. In some embodiments, registered users of online software 42 are also, automatically, registered users of search interface 40. In other embodiments, search interface 40 is part of a separate application that may include a separate registration process. In those other embodiments, a portion of search interface 40 creates and stores, in an electronic file or a mapping table, for example, a mapping that links the member registration data stored in online software 42 with the member registration data stored in search interface 40, to facilitate the exchange of data between the two systems.

Online software 42 is software that is designed to provide a networking service for its members, such as a professional networking service or an online social network service. End users become members of online software 42 through a registration process that includes establishing a user account identifier, password, and online profile. An example of online software 42 is the online professional social network service known as LINKEDIN, provided by LinkedIn Corporation of Sunnyvale, Calif. Search interface 40 is depicted separately from online software 42 in FIG. 2; however, search interface 40 is part of online software 42 in some embodiments.

Candidate generation software 48 obtains query string 52 and context data 54 from search interface 40, and also obtains context data 56 from online software 42. Query string 52 is a text stream that has been input to an input box or field of search interface 40. Query string 52 includes a sequence of alphanumeric characters such as a word, a phrase, or a portion of text such as an n-gram. Query string 52 may have been input into the input field via any type of input mechanism including but not limited to a keyboard or a microphone coupled to an automated speech recognition (ASR) system or other form of speech-to-text technology.

Context data 54 includes data extracted from another part of search interface 40. Examples of context data 54 include but are not limited to text input into one or more other input fields of search interface 40 and data values selected via a graphical user interface element such as a list box, slider bar, radio button or check box. Context data 56 includes data extracted from online software 42. Examples of context data 56 include but are not limited to member profile data, such as company name, job title, occupation, etc., of a member profile that is associated with member registration data for the user who supplied query string 52. If search interface 40 and online software 42 are not part of the same application and member approval has been obtained (for example, the member has agreed to share their data with other applications), then, to obtain context data 56, member registration data associated with query string 52 is mapped to corresponding member registration data in online software 42.

Candidate generation software 48 receives query string 52 and context data 54 from search interface 40 and receives context data 56 from online software 42 as a result of one or more data extraction and standardization processes, which extract the desired data from search interface 40 and online software 42, respectively, and stores the extracted data in an electronic file. The data extraction and standardization processes disclosed herein are implemented using computer code that is written in a programming language, such as Python.

Candidate generation software 48 uses query string 52, context data 54 and context data 56, as well as taxonomy data 44 and weight data 46, to generate and output a set of candidate entities 58. If either or both of context data 54 or context data 56 are not available, then candidate generation software 48 generates and outputs the set of candidate entities using query string 52. In an embodiment, candidate generation software 48 executes machine readable code by which one or more portions of process 10 are implemented on a computer; for example, operations 12, 14, 16, and 18 of process 10, described above with reference to FIG. 1.

Taxonomy data 44 is a subset of data that is contained in taxonomy 106. Taxonomy data 44 includes a portion of taxonomy 106 that relates to query string 52 and optionally to context data 54 and/or context data 56. In an embodiment, taxonomy data 44 is traversed to identify canonical and/or non-canonical entities that map to query string 52 in view of context data 54 and/or context data 56. In an embodiment, portions of taxonomy data 44 are indexed using in-memory indexing.

Weight data 46 is stored data that is associated with search service(s) 102. Weight data is adjustable programmatically or by user input and may be stored in or linked to data source(s) 104. Examples of weight data 46 are numerical values that represent the relative importance of a particular entity type, attribute, attribute value, or search service in comparison to other entity types, attributes, attribute values, or search services. Weight data 46 is used by ranking logic 124 to sort sets of candidate entities. In some embodiments, weight data 46 includes a canonical bias and/or a completeness bias. A canonical bias causes canonical entities to be ranked higher than non-canonical entities, in some embodiments. A completeness bias causes complete entities to be ranked higher than entities that are not complete. Whether an entity is canonical, non-canonical, incomplete, or complete, is determined using a taxonomy, in some embodiments.

Weight data 46 that relates to search services is adjustable based on, for example, latency and/or recall. Weight data 46 is configurable in accordance with the requirements of a particular application in which the disclosed typeahead functionality is used. For example, in an application where low latency is a priority, weight data 46 may be higher for search services that have low latency and lower for search services that do not have low latency.

Candidate generation software 48 generates one or more search queries that contain query string 52, context data 54, context data 56, and portions of taxonomy data 44, and sends those search queries to one or more search services 102. To improve latency, these queries are sent to search services 102 in parallel or concurrently, in an embodiment. Weight data 46 may be used to determine an order of priority in which search services 102 are called or weight data 46 may be used to rank the results returned by particular search services 102 in accordance with their respective weight data 46. The search services 102 individually return respective result sets of candidate entities which are combined or concatenated by candidate generation software 48 to produce the set of candidate entities 58. Candidate generation software 48 outputs and transmits or otherwise makes available the set of candidate entities 58 for use by ranking software 50.

Ranking software 50 receives, via an API, for example, the set of candidate entities 58 output by candidate generation software 48. Ranking software 50 sorts the set of candidate entities 58 according to one or more ranking criteria. In an embodiment, ranking software 50 executes machine readable code by which one or more portions of process 10 are implemented on a computer; for example, one or more portions of operation 20 of process 10, described above with reference to FIG. 1. In other embodiments, ranking software 50 ranks the set of candidate entities 58 according to frequency of occurrence in member profiles of online software 42. Ranking software 50 may truncate the sorted set of candidate entities 58 in accordance with the requirements and limitations of search interface 40; for example, a size limitation of a list box. Ranking software 50 outputs the final list of candidate entities 58 as suggestion list 60.

Suggestion list 60 is returned to search interface 40 for use in query formulation. For example, the entities in suggestion list 60 are displayed in a list box adjacent to the input field in which query string 52 was input. An entity can be selected from suggestion list 60, for example by user interaction with search interface 40. In response to selection of an entity from suggestion list 60, the selected entity replaces query string 52 in the input field to aid in query formulation. Once the search query is finalized, search interface 40 cooperates with a search engine, which may be one of search services 102 or another search service, to execute the query that has been formulated using suggestion list 60.

### Networked System Example

FIG. 3 is a block diagram of a networked computing system in which typeahead service 120 may be implemented, for example as part of search interface 40 or as part of online software 42 or as an application program interface (API) that is callable by online software 42 or search interface 40.

Computing system 300 includes at least computing device(s) 100, computing device 160, and display device 170, which are communicatively coupled to an electronic communications network 140. Implemented in the devices 100, 160, 170 using computer software, hardware, or software and hardware, are combinations of automated functionality embodied in computer programming code, data structures, and digital data, which are represented schematically in FIG. 1 as search service(s) 102, data source(s) 104, taxonomy 106, online system 108, connection graph 110, management system 112, typeahead service 120, context logic 122, ranking logic 124, graphical user interface 130, search interface 132. System as used in this disclosure may refer to a single computer or network of computers and/or other devices. Computing device as used in this disclosure may refer to a computer or any other electronic device that is equipped with a processor.

Although computing system 300 may be implemented with any number N (where N is a positive integer) of search service(s) 102, data source(s) 104, taxonomy 106, online system 108, connection graph 110, management system 112, typeahead service 120, context logic 122, ranking logic 124, graphical user interface 130, search interface 132, computing devices 100, display devices 170 and computing devices 160, respectively, in this disclosure, these elements may be referred to in the singular form for ease of discussion.

Also, search service(s) 102, data source(s) 104, taxonomy 106, online system 108, connection graph 110, management system 112, typeahead service 120, context logic 122, ranking logic 124, graphical user interface 130, search interface 132 are shown as separate elements in FIG. 1 for ease of discussion but the illustration is not meant to imply that separation of these elements is required. The illustrated systems (or their functionality) may be divided over any number of physical systems, including a single physical computer system, and can communicate with each other in any appropriate manner.

The illustrative search service(s) 102, data source(s) 104, taxonomy 106, online system 108, connection graph 110, management system 112, typeahead service 120, context logic 122, ranking logic 124, graphical user interface 130, search interface 132 are communicatively coupled to computing device 160 and to network 140. Portions search service(s) 102, data source(s) 104, taxonomy 106, online system 108, connection graph 110, management system 112, typeahead service 120, context logic 122, ranking logic 124, graphical user interface 130, search interface 132 may be implemented as web-based software applications or mobile device applications and hosted by a hosting service (not shown). For example, graphical user interface 130 may be implemented within a front-end portion management system 112 or within a front-end portion of online system 108, or may be embedded within another application. In an embodiment, portions of graphical user interface 130 are implemented in a web browser that can be executed on computing device 160.

In some embodiments, computing device 160 is a client computing device, such as an end user's smart phone, tablet computer, mobile communication device, wearable device, embedded system, smart appliance, desktop computer, or laptop machine, and computing device 100 is a server computer or network of server computers located on the Internet, in the cloud. As illustrated in FIG. 1, display device 170 is implemented in computing device 160 but may be implemented as a separate device or as part of another device, or as multiple networked display devices, in other implementations.

Search service(s) 102 includes one or more search engines that have been configured to search one or more data source(s) 104. In an embodiment, search service(s) 102 are implemented using a federated searching process and a search architecture such as APACHE LUCENE or LINKEDIN GALENE.

The example search service(s) 102 includes data source(s) 104 and taxonomy 106. Data source(s) 104 are individually or collectively implemented as a searchable database system, such as a graph-based database system or a table-based relational database system or a hierarchical database system, or as a flat electronic file, for example. The data stored in data source(s) 104 may include numerous data records, where a data record may indicate, for example, entity data that includes one or more of: a member identifier, a job identifier, a company name, a job title, a job description, a list of skills. In an embodiment, data source(s) 104 contain data that has been extracted from online system 108.

Taxonomy 106 includes a subset of the entity data stored in data source(s) 104 and indicates logical relationships between entities and entity types. In an embodiment, taxonomy indicates relationships between canonical entities and non-canonical entities of particular entity types. Examples of entity types include but are not limited to title, skill, occupation, role, specialty. Example of a canonical entity is a standardized term for a job title, such as Software Engineer. Example of a non-canonical entity is an alias, synonym, or similar term for a canonical entity, such as Software Developer. Taxonomy 106 is implemented using a searchable data structure, such as a digital ontology or a graph-based database system or a relational database system.

Online system 108 is a computer-implemented networking service for entities, such as a professional networking service or an online social network, in an embodiment. An example of online system 108 is the LINKEDIN software, which is commercially available from LinkedIn Corporation of Sunnyvale, Calif. Online system 108 uses connection graph 110 to store data. Connection graph 110 contains nodes that represent entities, such as members and companies, using online system 108. Data associated with nodes and connections between nodes are represented in connection graph 110. In the context of online system 108, “node” may refer to a software abstraction of entity data and need not be tied to any particular hardware or machine that is connected to network 140.

Digital data, such as member profile data, job profile data, and/or other context data, is extracted from one or more nodes of connection graph 110 periodically or in response to an event or a command. Digital data is extracted from online system 108 using, for example, an export function. In an embodiment, a logging service is used to extract digital data from online system 108 using SAMZA (open-source software for near-real time, asynchronous stream processing, provided by the Apache Software Foundation). In an embodiment, digital data is output for use by typeahead service 120 using KAFKA (open-source software for building real-time data pipelines, provided by the Apache Software Foundation). Other software products providing similar or equivalent functionality as the software products mentioned in this disclosure are used in other embodiments.

Management system 112 is, in an embodiment, a computer-implemented system that interfaces with online system 108 to provide domain-specific functionality using connection graph 110. Examples of management system 112 include but are not limited to the “Jobs” component of the LINKEDIN mobile device software application, and LINKEDIN TALENT SOLUTIONS, both provided by LinkedIn Corporation of Sunnyvale, Calif. Other examples of management system 112 include other commercially available online job listing services.

Typeahead service 120 provides a programmable interface that is coupled to search service(s) 102 and to online system 108 and/or management system 112 via network 140. Typeahead service 120 performs automated suggestion list generation as described in this disclosure. In an embodiment, context logic 122 obtains context data from online system 108 and/or management system 112 and/or search interface 132 and uses the context data to generate a set of candidate entities for a suggestion list. Portions of candidate generation software 48, described above, are implemented as part of context logic 122 of typeahead service 120, in an embodiment.

In an embodiment, ranking logic 124 receives the set of candidate entities output by context logic 122 and sorts the set of candidate entities according to one or more ranking criteria, which may include, for example, whether a particular entity value is a canonical entity or a non-canonical entity, whether a particular entity value is complete or incomplete as determined by reference to taxonomy 106, whether a particular entity value has a high frequency of occurrence across an online connection network, and/or other ranking criteria. Portions of ranking software 50, described above, are implemented as part of ranking logic 124 of typeahead service 120, in an embodiment.

While not specifically shown, a presentation layer may be part of online system 108 and/or management system 112 and/or typeahead service 120. A presentation layer is server-side software that provides data conversion and data translation services, in an embodiment. A presentation layer facilitates the generation of search interface 132 that includes query input fields, list boxes, suggestion lists and/or elements and information, for presentation by graphical user interface 130 as part of search interface 132, in an embodiment.

Network 140 is an electronic communications network and may be implemented on any medium or mechanism that provides for the exchange of data between the devices that are connected to the network. Examples of network 140 include, without limitation, a network such as a Local Area Network (LAN), Wide Area Network (WAN), Ethernet or the Internet, or one or more terrestrial, satellite or wireless links.

Computing device 160 communicates with display device 170 and operates graphical user interface 130 to establish logical connection(s) over network 140 with portions of search service(s) 102, online system 108, management system 112, either directly or via typeahead service 120. Search interface 132 is an arrangement of graphical user interface elements, such as text input boxes, list boxes, interactive elements and links, in an embodiment. Search interface 132 can be embedded in a web-based application front end or a mobile device application front end, using for example an HTML (Hyper-Text Markup Language) document. In some embodiments, search interface 132 includes audio output or a combination of audio and visual output. Examples of portions of search interface 132 are shown in FIGS. 4A and 4B, described below.

### Examples of Suggestion Lists

FIG. 4A and FIG. 4B are screen captures of examples of typeahead suggestion list output 400, 420, in an embodiment. Output 400, 420 are designed to be displayed in search interface 132 of graphical user interface 130, in an embodiment. In FIG. 4A, the output 400 includes an input box 402 and a list box 406. In operation, input box 402 receives text input, for example a query string, “deep learning.” In response to the inputting of the query string into input box 402, the system generates a suggestion list using the disclosed technologies and displays entries from the suggestion list in rank order according to the applicable ranking logic, within list box 406.

FIG. 4A illustrates that the disclosed technologies can produce a suggestion list that contains candidate entities that do not match the prefix of the query string. Although none of the entries in list box 406 match the word “deep,” the candidate entities in list box 406 are clearly highly relevant because deep learning is a sub-specialty of machine learning. Moreover, the candidate entity 408, illustrates that the system determined that Learning Specialist was a frequently used title across member profiles on the online connection network having to do with machine learning, and therefore included it in the suggestion list even though the title, Learning Specialist, without context, is not clearly identifiable as relating to deep learning. In contrast to the disclosed technologies, existing typeahead technologies would only display, in list box 406, entries with the prefix, “deep” and as such would very likely include many irrelevant entries, such as Deep Sea Diver.

In FIG. 4B, the output 420 includes context data 422, an input box 424, and a list box 426. In operation, context data 422 has been input or selected prior to a text stream being input into input box 424. Input box 424 receives text input, for example a query string, “software.” In response to the inputting of the query string into input box 424, the disclosed technologies generate a suggestion list using the query string of input box 424 and the context data 422, and displays entries from the suggestion list in rank order according to the applicable ranking logic, within list box 426.

FIG. 4B illustrates that the disclosed technologies can use context data to produce a suggestion list that contains highly relevant suggestions even though the text stream entered into input box 424 is very general in nature. The context data 422 increases the relevance of the candidate entity Data Scientist 430 and therefore Data Scientist is included in the suggestion list. The context data 422 coupled with the query string software also helps clarify that the suggestion list should pertain to titles of people working in technology development as opposed to some other software-related field like software patent lawyers or software sales agents. As a result, titles like Java Software Engineer 428 are included in the suggestion list even though the prefix Java does not match any part of the query string or the context data.

As illustrated by FIG. 4A and FIG. 4B, the disclosed technologies improve the quality of the candidate entities that are selected for and displayed in the typeahead suggestion list. Another benefit of improving the quality of the suggestion list is that it implicitly encourages users to select more complete or more precise search terms.

### Implementation Example—Hardware Overview

According to one embodiment, the techniques described herein are implemented by one or more computing devices. For example, portions of the disclosed technologies may be at least temporarily implemented on a network including a combination of one or more server computers and/or other computing devices. The computing devices may be hard-wired to perform the techniques or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such computing devices may also combine custom hard-wired logic, ASICs, or FPGAs with custom programming to accomplish the described techniques.

The computing devices may be server computers, personal computers, or a network of server computers and/or personal computers. Illustrative examples of computers are desktop computer systems, portable computer systems, handheld devices, mobile computing devices, wearable devices, body mounted or implantable devices, smart phones, smart appliances, networking devices, autonomous or semi-autonomous devices such as robots or unmanned ground or aerial vehicles, or any other electronic device that incorporates hard-wired and/or program logic to implement the described techniques.

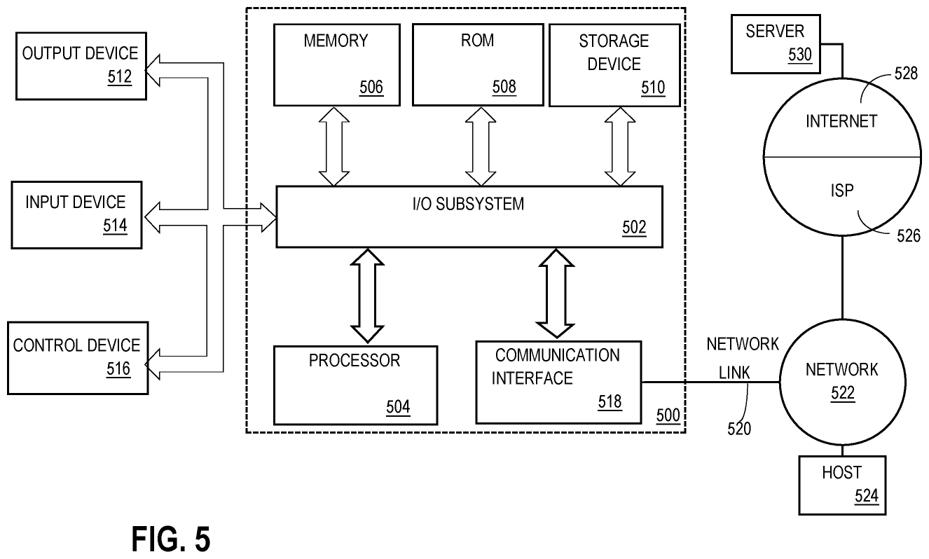

For example, FIG. 5 is a block diagram that illustrates a computer system 500 upon which an embodiment of the present invention may be implemented. Components of the computer system 500, including instructions for implementing the disclosed technologies in hardware, software, or a combination of hardware and software, are represented schematically in the drawings, for example as boxes and circles.

Computer system 500 includes an input/output (I/O) subsystem 502 which may include a bus and/or other communication mechanism(s) for communicating information and/or instructions between the components of the computer system 500 over electronic signal paths. The I/O subsystem may include an I/O controller, a memory controller and one or more I/O ports. The electronic signal paths are represented schematically in the drawings, for example as lines, unidirectional arrows, or bidirectional arrows.

One or more hardware processors 504 are coupled with I/O subsystem 502 for processing information and instructions. Hardware processor 504 may include, for example, a general-purpose microprocessor or microcontroller and/or a special-purpose microprocessor such as an embedded system or a graphics processing unit (GPU) or a digital signal processor.

Computer system 500 also includes a memory 506 such as a main memory, which is coupled to I/O subsystem 502 for storing information and instructions to be executed by processor 504. Memory 506 may include volatile memory such as various forms of random-access memory (RAM) or other dynamic storage device. Memory 506 also may be used for storing temporary variables or other intermediate information during execution of instructions to be executed by processor 504. Such instructions, when stored in non-transitory computer-readable storage media accessible to processor 504, render computer system 500 into a special-purpose machine that is customized to perform the operations specified in the instructions.

Computer system 500 further includes a non-volatile memory such as read only memory (ROM) 508 or other static storage device coupled to I/O subsystem 502 for storing static information and instructions for processor 504. The ROM 508 may include various forms of programmable ROM (PROM) such as erasable PROM (EPROM) or electrically erasable PROM (EEPROM). A persistent storage device 510 may include various forms of non-volatile RAM (NVRAM), such as flash memory, or solid-state storage, magnetic disk or optical disk, and may be coupled to I/O subsystem 502 for storing information and instructions.

Computer system 500 may be coupled via I/O subsystem 502 to one or more output devices 512 such as a display device. Display 512 may be embodied as, for example, a touch screen display or a light-emitting diode (LED) display or a liquid crystal display (LCD) for displaying information, such as to a computer user. Computer system 500 may include other type(s) of output devices, such as speakers, LED indicators and haptic devices, alternatively or in addition to a display device.

One or more input devices 514 is coupled to I/O subsystem 502 for communicating signals, information and command selections to processor 504. Types of input devices 514 include touch screens, microphones, still and video digital cameras, alphanumeric and other keys, buttons, dials, slides, and/or various types of sensors such as force sensors, motion sensors, heat sensors, accelerometers, gyroscopes, and inertial measurement unit (IMU) sensors and/or various types of transceivers such as wireless, such as cellular or Wi-Fi, radio frequency (RF) or infrared (IR) transceivers and Global Positioning System (GPS) transceivers.

Another type of input device is a control device 516, which may perform cursor control or other automated control functions such as navigation in a graphical interface on a display screen, alternatively or in addition to input functions. Control device 516 may be implemented as a touchpad, a mouse, a trackball, or cursor direction keys for communicating direction information and command selections to processor 504 and for controlling cursor movement on display 512. The input device may have at least two degrees of freedom in two axes, a first axis (e.g., x) and a second axis (e.g., y), that allows the device to specify positions in a plane. Another type of input device is a wired, wireless, or optical control device such as a joystick, wand, console, steering wheel, pedal, gearshift mechanism or other type of control device. An input device 514 may include a combination of multiple different input devices, such as a video camera and a depth sensor.

Computer system 500 may implement the techniques described herein using customized hard-wired logic, one or more ASICs or FPGAs, firmware and/or program logic which in combination with the computer system causes or programs computer system 500 to operate as a special-purpose machine. According to one embodiment, the techniques herein are performed by computer system 500 in response to processor 504 executing one or more sequences of one or more instructions contained in memory 506. Such instructions may be read into memory 506 from another storage medium, such as storage device 510. Execution of the sequences of instructions contained in memory 506 causes processor 504 to perform the process steps described herein. In alternative embodiments, hard-wired circuitry may be used in place of or in combination with software instructions.

The term “storage media” as used in this disclosure refers to any non-transitory media that store data and/or instructions that cause a machine to operation in a specific fashion. Such storage media may comprise non-volatile media and/or volatile media. Non-volatile media includes, for example, optical or magnetic disks, such as storage device 510. Volatile media includes dynamic memory, such as memory 506. Common forms of storage media include, for example, a hard disk, solid state drive, flash drive, magnetic data storage medium, any optical or physical data storage medium, memory chip, or the like.

Storage media is distinct from but may be used in conjunction with transmission media. Transmission media participates in transferring information between storage media. For example, transmission media includes coaxial cables, copper wire and fiber optics, including the wires that comprise a bus of I/O subsystem 502. Transmission media can also take the form of acoustic or light waves, such as those generated during radio-wave and infra-red data communications.

Various forms of media may be involved in carrying one or more sequences of one or more instructions to processor 504 for execution. For example, the instructions may initially be carried on a magnetic disk or solid-state drive of a remote computer. The remote computer can load the instructions into its dynamic memory and send the instructions over a communication link such as a fiber optic or coaxial cable or telephone line using a modem. A modem or router local to computer system 500 can receive the data on the communication link and convert the data to a format that can be read by computer system 500. For instance, a receiver such as a radio frequency antenna or an infrared detector can receive the data carried in a wireless or optical signal and appropriate circuitry can provide the data to I/O subsystem 502 such as place the data on a bus. I/O subsystem 502 carries the data to memory 506, from which processor 504 retrieves and executes the instructions. The instructions received by memory 506 may optionally be stored on storage device 510 either before or after execution by processor 504.

Computer system 500 also includes a communication interface 518 coupled to bus 502. Communication interface 518 provides a two-way data communication coupling to network link(s) 520 that are directly or indirectly connected to one or more communication networks, such as a local network 522 or a public or private cloud on the Internet. For example, communication interface 518 may be an integrated-services digital network (ISDN) card, cable modem, satellite modem, or a modem to provide a data communication connection to a corresponding type of communications line, for example a coaxial cable or a fiber-optic line or a telephone line. As another example, communication interface 518 may include a local area network (LAN) card to provide a data communication connection to a compatible LAN. Wireless links may also be implemented. In any such implementation, communication interface 518 sends and receives electrical, electromagnetic or optical signals over signal paths that carry digital data streams representing various types of information.

Network link 520 typically provides electrical, electromagnetic, or optical data communication directly or through one or more networks to other data devices, using, for example, cellular, Wi-Fi, or BLUETOOTH technology. For example, network link 520 may provide a connection through a local network 522 to a host computer 524 or to other computing devices, such as personal computing devices or Internet of Things (IoT) devices and/or data equipment operated by an Internet Service Provider (ISP) 526. ISP 526 provides data communication services through the world-wide packet data communication network commonly referred to as the “Internet” 528. Local network 522 and Internet 528 both use electrical, electromagnetic or optical signals that carry digital data streams. The signals through the various networks and the signals on network link 520 and through communication interface 518, which carry the digital data to and from computer system 500, are example forms of transmission media.

Computer system 500 can send messages and receive data and instructions, including program code, through the network(s), network link 520 and communication interface 518. In the Internet example, a server 530 might transmit a requested code for an application program through Internet 528, ISP 526, local network 522 and communication interface 518. The received code may be executed by processor 504 as it is received, and/or stored in storage device 510, or other non-volatile storage for later execution.

### Additional Examples

Illustrative examples of the technologies disclosed herein are provided below. An embodiment of the technologies may include any of the examples or a combination of the described below.

In an example 1, a method for generating a typeahead suggestion list for an input field of a search interface includes: receiving, as digital input, a query string that has been extracted from the input field and context data that includes one or more of: a search term that has been extracted from another input field of the search interface or a search criterion that has been extracted from a member profile that is associated with the query string via an online connection network; executing, on digital data extracted from the online connection network, one or more machine-readable queries that include one or more of the query string and the context data, to produce a set of candidate entities; outputting at least part of the set of candidate entities as a suggestion list that the search interface may display in association with the input field to facilitate query formulation via the input field; where the method is performed by one or more computing devices.

An example 2 includes the subject matter of example 1, including traversing a digital taxonomy to determine a canonical name for a non-canonical entity of the set of candidate entities and including the canonical name in the suggestion list in place of the non-canonical entity. An example 3 includes the subject matter of example 2, including, in response to determining that a frequency of occurrence of the non-canonical entity in member profiles of the online connection network exceeds a threshold, adding the non-canonical entity to the suggestion list. An example 4 includes the subject matter of example 2, including traversing the digital taxonomy in volatile memory of the one or more computing devices. An example 5 includes the subject matter of any of examples 1-4, including: using a federated search process to coordinate searching of the digital data extracted from the online connection network by a plurality of distributed search services and combine results retrieved by the plurality of distributed search services to generate the set of candidate entities. An example 6 includes the subject matter of example 5, including ranking entities retrieved by search services of the plurality of distributed search services according to a latency bias, where the latency bias causes entities retrieved by a search service that has a lower latency to be ranked higher than entities retrieved by a search service that has a higher latency when low latency is preferred and the latency bias causes entities retrieved by a search service that has a higher latency to be ranked higher than entities retrieved by a search service that has a lower latency when search quality is preferred. An example 7 includes the subject matter of any of examples 1-6, including: extracting the query string from the input field; where the input field has received the query string via an input device; displaying the suggestion list in a list box that is adjacent to the input field on the search interface. An example 8 includes the subject matter of any of examples 1-7, including: in response to a selection identifying a selected entity in the suggestion list, replacing the query string with the selected entity in the input field.

In an example 9, a method for generating a typeahead suggestion list for an input field of a search interface includes: receiving, as digital input, a query string that has been extracted from the input field; inputting the query string to an automated search process that outputs, in response to the query string, a set of candidate entities; where the set of candidate entities includes at least one canonical entity; ranking entities in the set of candidate entities according to a canonical bias to produce a suggestion list; where the canonical bias causes canonical entities to be ranked higher than non-canonical entities; where an entity is determined to be canonical or non-canonical using a digital taxonomy that has been constructed at least in part using data extracted from an online connection network; outputting at least part of the set of candidate entities as a suggestion list that the search interface may display in association with the input field to facilitate query formulation via the input field; where the method is performed by one or more computing devices.

An example 10 includes the subject matter of example 9, including: ranking the entities in the set of candidate entities according to a completeness bias; where the completeness bias causes complete entities to be ranked higher than entities that are not complete; where an entity is determined to be complete or incomplete using the digital taxonomy. An example 11 includes the subject matter of example 10, including ranking the entities in the set of candidate entities according to an attribute bias; where the attribute bias causes entities that contain a value for a particular attribute to be ranked higher than entities that do not contain a value for the particular attribute; where an entity is determined to contain or not contain a value for the particular attribute using the digital taxonomy. An example 12 includes the subject matter of example 11, where an entity of the set of candidate entities contains a job title, the job title has at least one of an occupation attribute, a role attribute, or a specialty attribute, and the method includes one or more of: ranking entities that contain a value for the occupation attribute higher than entities that do not contain a value for the occupation attribute, or ranking entities that contain a value for the role attribute higher than entities that contain a value for the specialty attribute. An example 13 includes the subject matter of example 9, including: extracting the query string from the input field; where the input field has received the query string via an input device; displaying the suggestion list in a list box that is adjacent to the input field on the search interface. An example 14 includes the subject matter of example 9, including: in response to a selection identifying a selected entity in the suggestion list, replacing the query string with the selected entity in the input field.

In an example 15, An apparatus including one or more non-transitory computer-readable storage media storing instructions which, when executed by one or more processors, cause: receiving, as digital input, a query string that has been extracted from the input field and context data that includes one or more of: a search term that has been extracted from another input field of the search interface or a search criterion that has been extracted from a member profile that is associated with the query string via an online connection network; executing, on digital data extracted from the online connection network, one or more machine-readable queries that include one or more of the query string and the context data, to produce a set of candidate entities; outputting at least part of the set of candidate entities as a suggestion list that the search interface may display in association with the input field to facilitate query formulation via the input field.

An example 16 includes the subject matter of example 15, where the instructions, when executed by the one or more processors, further cause: using a digital taxonomy that has been constructed at least in part using data extracted from the online connection network, determining that the set of candidate entities includes at least one canonical entity; ranking entities in the set of candidate entities according to a canonical bias to produce a suggestion list; where the canonical bias causes canonical entities to be ranked higher than non-canonical entities. An example 17 includes the subject matter of example 16, where the instructions, when executed by the one or more processors, further cause, in response to determining that a frequency of occurrence of a non-canonical entity in member profiles of the online connection network exceeds a threshold, increasing a ranking of the non-canonical entity. An example 18 includes the subject matter of example 15, where the instructions, when executed by the one or more processors, further cause: ranking the entities in the set of candidate entities according to a completeness bias; where the completeness bias causes complete entities to be ranked higher than entities that are not complete; where an entity is determined to be complete or incomplete using a digital taxonomy that has been constructed at least in part using data extracted from the online connection network. An example 19 includes the subject matter of example 15, where the instructions, when executed by the one or more processors, further cause: extracting the query string from the input field; where the input field has received the query string via an input device; displaying the suggestion list in a list box that is adjacent to the input field on the search interface. An example 20 includes the subject matter of example 15, where the instructions, when executed by the one or more processors, further cause: in response to a selection identifying a selected entity in the suggestion list, replacing the query string with the selected entity in the input field.

General Considerations

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

Any definitions set forth herein for terms contained in the claims may govern the meaning of such terms as used in the claims. No limitation, element, property, feature, advantage or attribute that is not expressly recited in a claim should limit the scope of the claim in any way. The specification and drawings are to be regarded in an illustrative rather than a restrictive sense.

As used in this disclosure the terms “include” and “comprise” (and variations of those terms, such as “including,” “includes,” “comprising,” “comprises,” “comprised” and the like) are intended to be inclusive and are not intended to exclude further features, components, integers or steps.

References in this document to “an embodiment,” etc., indicate that the embodiment described or illustrated may include a particular feature, structure, or characteristic, but every embodiment may not necessarily include the particular feature, structure, or characteristic. Such phrases are not necessarily referring to the same embodiment. Further, when a particular feature, structure, or characteristic is described or illustrated in connection with an embodiment, it is believed to be within the knowledge of one skilled in the art to effect such feature, structure, or characteristic in connection with other embodiments whether or not explicitly indicated.

Various features of the disclosure have been described using process steps. The functionality/processing of a given process step could potentially be performed in different ways and by different systems or system modules. Furthermore, a given process step could be divided into multiple steps and/or multiple steps could be combined into a single step. Furthermore, the order of the steps can be changed without departing from the scope of the present disclosure.

It will be understood that the embodiments disclosed and defined in this specification extend to alternative combinations of the individual features and components mentioned or evident from the text or drawings. These different combinations constitute various alternative aspects of the embodiments.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method for generating a typeahead suggestion list for an input field of a search interface, the method comprising:
receiving, as digital input, a query string that has been extracted from the input field and context data that comprises one or more of: a search term that has been extracted from another input field of the search interface or a search criterion that has been extracted from a member profile that is associated with the query string via an online connection network;
executing, on digital data extracted from the online connection network, one or more machine-readable queries that comprise one or more of the query string and the context data, to produce a set of candidate entities;
outputting at least part of the set of candidate entities as a suggestion list that the search interface may display in association with the input field to facilitate query formulation via the input field;
wherein the method is performed by one or more computing devices.

2. The method of claim 1, comprising traversing a digital taxonomy to determine a canonical name for a non-canonical entity of the set of candidate entities and including the canonical name in the suggestion list in place of the non-canonical entity.

3. The method of claim 2, comprising, in response to determining that a frequency of occurrence of the non-canonical entity in member profiles of the online connection network exceeds a threshold, adding the non-canonical entity to the suggestion list.

4. The method of claim 2, comprising traversing the digital taxonomy in volatile memory of the one or more computing devices.

5. The method of claim 1, comprising:
using a federated search process to coordinate searching of the digital data extracted from the online connection network by a plurality of distributed search services and combine results retrieved by the plurality of distributed search services to generate the set of candidate entities.

6. The method of claim 5, comprising ranking entities retrieved by search services of the plurality of distributed search services according to a latency bias, wherein the latency bias causes entities retrieved by a search service that has a lower latency to be ranked higher than entities retrieved by a search service that has a higher latency when low latency is preferred and the latency bias causes entities retrieved by a search service that has a higher latency to be ranked higher than entities retrieved by a search service that has a lower latency when search quality is preferred.

7. The method of claim 1, comprising:
extracting the query string from the input field;
wherein the input field has received the query string via an input device;
displaying the suggestion list in a list box that is adjacent to the input field on the search interface.

8. The method of claim 1, comprising:
in response to a selection identifying a selected entity in the suggestion list, replacing the query string with the selected entity in the input field.

9. A method for generating a typeahead suggestion list for an input field of a search interface, the method comprising:
receiving, as digital input, a query string that has been extracted from the input field;
inputting the query string to an automated search process that outputs, in response to the query string, a set of candidate entities;
wherein the set of candidate entities comprises at least one canonical entity;
ranking entities in the set of candidate entities according to a canonical bias to produce a suggestion list;
wherein the canonical bias causes canonical entities to be ranked higher than non-canonical entities;
wherein an entity is determined to be canonical or non-canonical using a digital taxonomy that has been constructed at least in part using data extracted from an online connection network;
outputting at least part of the set of candidate entities as a suggestion list that the search interface may display in association with the input field to facilitate query formulation via the input field;
wherein the method is performed by one or more computing devices.

10. The method of claim 9, comprising:
ranking the entities in the set of candidate entities according to a completeness bias;
wherein the completeness bias causes complete entities to be ranked higher than entities that are not complete;
wherein an entity is determined to be complete or incomplete using the digital taxonomy.

11. The method of claim 10, comprising
ranking the entities in the set of candidate entities according to an attribute bias;
wherein the attribute bias causes entities that contain a value for a particular attribute to be ranked higher than entities that do not contain a value for the particular attribute;
wherein an entity is determined to contain or not contain a value for the particular attribute using the digital taxonomy.

12. The method of claim 11, wherein an entity of the set of candidate entities contains a job title, the job title has at least one of an occupation attribute, a role attribute, or a specialty attribute, and the method comprises one or more of:
ranking entities that contain a value for the occupation attribute higher than entities that do not contain a value for the occupation attribute, or
ranking entities that contain a value for the role attribute higher than entities that contain a value for the specialty attribute.

13. The method of claim 9, comprising:
extracting the query string from the input field;
wherein the input field has received the query string via an input device;
displaying the suggestion list in a list box that is adjacent to the input field on the search interface.

14. The method of claim 9, comprising:
in response to a selection identifying a selected entity in the suggestion list, replacing the query string with the selected entity in the input field.

15. An apparatus comprising one or more non-transitory computer-readable storage media storing instructions which, when executed by one or more processors, cause:
receiving, as digital input, a query string that has been extracted from an input field of a search interface and context data that comprises one or more of: a search term that has been extracted from another input field of the search interface or a search criterion that has been extracted from a member profile that is associated with the query string via an online connection network;
executing, on digital data extracted from the online connection network, one or more machine-readable queries that comprise one or more of the query string and the context data, to produce a set of candidate entities;
outputting at least part of the set of candidate entities as a suggestion list that the search interface may display in association with the input field to facilitate query formulation via the input field.

16. The apparatus of claim 15, wherein the instructions, when executed by the one or more processors, further cause:
using a digital taxonomy that has been constructed at least in part using data extracted from the online connection network, determining that the set of candidate entities comprises at least one canonical entity;
ranking entities in the set of candidate entities according to a canonical bias to produce a suggestion list;
wherein the canonical bias causes canonical entities to be ranked higher than non-canonical entities.

17. The apparatus of claim 16, wherein the instructions, when executed by the one or more processors, further cause, in response to determining that a frequency of occurrence of a non-canonical entity in member profiles of the online connection network exceeds a threshold, increasing a ranking of the non-canonical entity.

18. The apparatus of claim 15, wherein the instructions, when executed by the one or more processors, further cause:
ranking entities in the set of candidate entities according to a completeness bias;
wherein the completeness bias causes complete entities to be ranked higher than entities that are not complete;
wherein an entity is determined to be complete or incomplete using a digital taxonomy that has been constructed at least in part using data extracted from the online connection network.

19. The apparatus of claim 15, wherein the instructions, when executed by the one or more processors, further cause:
extracting the query string from the input field;
wherein the input field has received the query string via an input device;
displaying the suggestion list in a list box that is adjacent to the input field on the search interface.

20. The apparatus of claim 15, wherein the instructions, when executed by the one or more processors, further cause:
in response to a selection identifying a selected entity in the suggestion list, replacing the query string with the selected entity in the input field.
